(19) United States
(12) Patent Application Publication
(10) Pub. No.: US 2015/0006101 A1
(43) Pub. Date: Jan. 1, 2015

(54) SERVER AND TEST METHOD

(71) Applicant: HON HAI PRECISION INDUSTRY CO., LTD., New Taipei (TW)

(72) Inventor: HSUAN-I LIN, New Taipei (TW)

(21) Appl. No.: 14/314,508

(22) Filed: Jun. 25, 2014

(30) Foreign Application Priority Data
Jun. 26, 2013 (TW) 102122628

(51) Int. Cl. G01M 99/00

(52) U.S. Cl. CPC G01M 99/002
USPC 702/108

(57) ABSTRACT

A test method includes the following. Set a plurality of test schedules in response to an input operation of a user, and store the set test schedules in a storage unit in sequence. Obtain a test schedule from the storage unit in sequence, and control the execution of a test process according to the test scheduling. In additional, output a test result after the test process is executed completely.

### CROSS-REFERENCE TO RELATED APPLICATIONS

This application claims priority to Taiwanese Patent Application No. 102122628 filed on Jun. 26, 2013 in the Taiwan Intellectual Property Office, the contents of which are incorporated by reference herein.

### FIELD

The present disclosure relates to devices, and particularly to a server, and a method thereof.

### BACKGROUND

A server is required to support a great number of electronic components, such as central processing units, storage devices, hard disk drives, program storage units, and PCI cards. A heat dissipation test of each electronic component is needed, and then a corresponding fan speed is designed for each electronic component to ensure that the temperature of the corresponding electronic component is at a preset value at any load combination. In addition, generate a fan table including the corresponding fan speeds of all electronic components and the corresponding load combinations.

### BRIEF DESCRIPTION OF THE DRAWINGS

Implementations of the present technology will now be described, by way of example only, with reference to the attached figures.

FIG. 1 is a block diagram of a server.

FIG. 2 is a flowchart diagram of an embodiment of a test method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

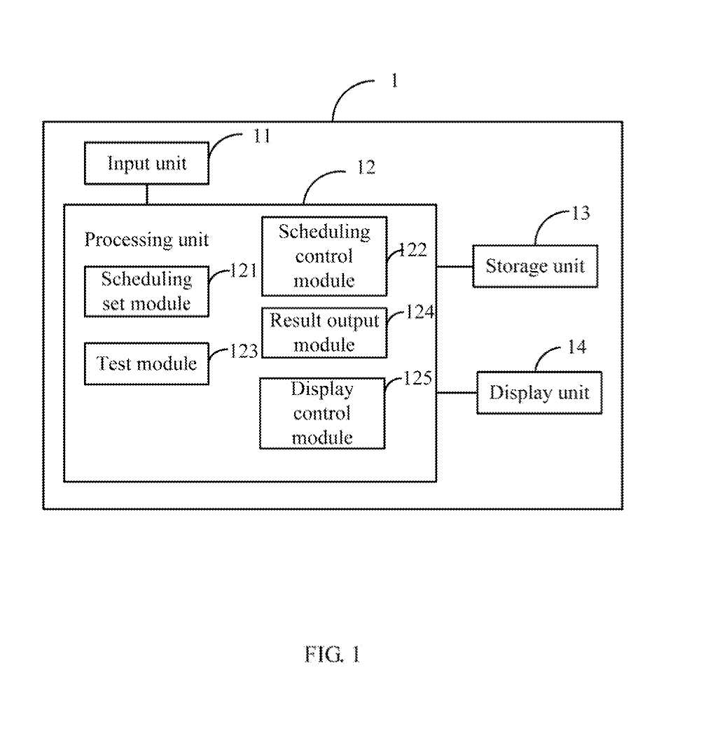

FIG. 1 illustrates a server 1 of the disclosure. The server 1 can include an input unit 11, a processing unit 12, a storage unit 13, a display unit 14, and a temperature detection unit 15.

The server 1 can include at least one combination of loads (not shown). The combination of loads includes a number of loads, such as a CPU, a memory, a hard drive, for example.

The input unit 11 coupled to the processing unit 12 is used to produce corresponding input signals in response to corresponding input operations of a user. The input unit 11 can be a touch screen, a keyboard, a touch pad, for example.

The processing unit 12 can be one or more processors. The processing unit 12 can include a scheduling set module 121, a scheduling control module 122, a test module 123, a result output module 124, and a display control module 125. In at least one embodiment, the scheduling set module 121, the scheduling control module 122, the test module 123, the result output module 124, and the display control module 125 are collection of software instructions stored in the storage unit 13 and executed by the processing unit 12. The processing unit 12 can be, for example, a digital signal processor, a single chip, or a central processing unit. The storage unit 13 can include one or more physical memory devices and the storage unit 13 can be a hard disk, a flash memory, a compact disk, and so on.

The scheduling set module 121 is used to set a number of test scheduling in response to the input operation of the user, and store the set test scheduling in the storage unit 13 in sequence.

The scheduling control module 122 is used to startup a test in response to an startup operation of the user input via the input unit 10, and to obtain a test scheduling from the storage unit 13 in sequence, and control the test module 123 to execute a test process according to the test scheduling.

The result output module 124 is used to output a test result after the test process is executed completely.

The display control module 125 is used to display the test result on the display unit 14.

In at least one embodiment, the display control module 125 further displays the number of set test schedules on the display unit 14.

In at least one embodiment, the scheduling control module 122 further determines whether there is at least one test schedule stored in the storage unit 13 that has not been tested. If there is the at least one test schedule stored in the storage unit 13 that has not been tested, the scheduling control module 122 obtains the next one test schedule that has not been tested, and controls the test module 126 to execute the test process according to the current obtained test schedule.

In at least one embodiment, the result output module 124 outputs the test result in table format.

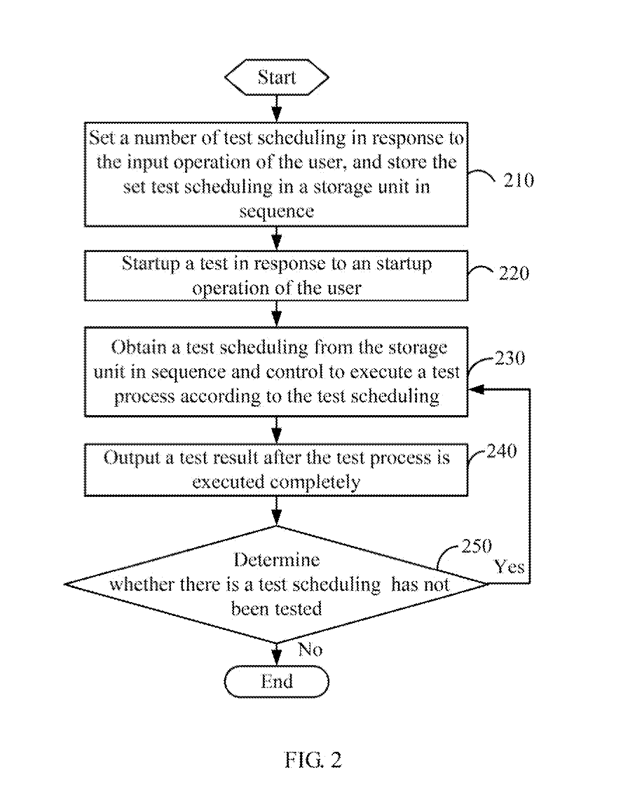

FIG. 2 illustrates a flowchart of a test method presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods or subroutines, carried out in the example method. Additionally, the illustrated order of blocks is by example only and the order of the blocks can change according to the present disclosure. The example method 300 can begin at block 210.

In block 210, a scheduling set module sets a number of test schedules in response to the input operation of the user, and stores the set test scheduling in a storage unit in sequence.

In block 220, a scheduling control module startups a test in response to an startup operation of the user input via an input unit.

In block 230, the scheduling control module obtains a test scheduling from the storage unit in sequence and controls a test module to execute a test process according to the test scheduling.

In block 240, a result output module outputs a test result after the test process is executed completely. In at least one embodiment, the result output module 124 outputs the test result in table format.

In block 250, the scheduling control module further determines whether there is at least one test schedule stored in the storage unit that has not been tested. If yes, the process returns to block 23, otherwise, the process is ended.

Therefore, in the present disclosure, time can be saved when setting the test scheduling.

The embodiments shown and described above are only examples. Many details are often found. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A server comprising:
an input unit configured to produce corresponding input signals in response to corresponding input operations of a user;
a storage unit;
a processing unit; and
a plurality of modules which are collections of instructions executed by the processing unit, the modules comprising:
a scheduling set module configured to set a plurality of test scheduling in response to the input operation of the user, and to store the set test scheduling in the storage unit in sequence;
a test module;
a scheduling control module configured to startup a test in response to an startup operation of the user input via the input unit, to obtain a test scheduling from the storage unit in sequence, and control the test module to execute a test process according to the test scheduling; and
a result output module configured to output a test result after the test process is executed completely.

2. The server according to claim 1, wherein the scheduling control module is further configured to determine whether there is at least one test scheduling stored in the storage unit has not been tested, and to obtain the next one test scheduling has not been tested, and control the test module to execute the test process according to the current obtained test scheduling if there is the at least one test scheduling has not been tested

3. The server according to claim 1, further comprising a display unit, wherein the modules further comprise a display control module configured to display the test result on the display unit.

4. The server according to claim 3, wherein the result output module outputs the test result with table formal.

5. A test method comprising:
setting a plurality of test scheduling in response to an input operation of a user, and storing the set test scheduling in a storage unit in sequence;
obtaining a test scheduling from the storage unit in sequence, and controlling to execute a test process according to the test scheduling; and
outputting a test result after the test process is executed completely.

6. The test method according to claim 5, further comprising:
determining whether there is at least one test scheduling stored in the storage unit has not been tested; and
obtaining the next one test scheduling has not been tested, and controlling the test module to execute the test process according to the current obtained test scheduling if there is the at least one test scheduling has not been tested.

7. The test method according to claim 5, further comprising:
displaying the test result on a display unit.

8. The test method according to claim 5, wherein the step of outputting a test result after the test process is executed completely comprises:
outputting the test result with table formal after the test process is executed completely.

9. A server comprising:
a processing unit having one or more processors;
an input device coupled to the processing unit and configured to detect a user input and output input signals in response to the user input;
a storage unit having one or more physical memory devices, wherein the storage unit is configured to store instructions in a plurality of modules for execution by the processing unit and the plurality of modules comprise:
a scheduling set module configured to set a plurality of test schedules in response to the user input and store the set test schedule in the storage unit in sequence;
a scheduling control module configured to:
start up a test in response to detection of a startup user input,
obtain a test schedule from the storage unit, and
control a test module to execute a test process according to the test schedule; and
a result output module configured to output a test result after the test process is executed completely.

10. The server according to claim 9, wherein the scheduling control module is further configured to determine whether there is at least one test scheduling stored in the storage unit has not been tested, and to obtain the next one test scheduling has not been tested, and control the test module to execute the test process according to the current obtained test scheduling if there is the at least one test scheduling has not been tested

11. The server according to claim 9, further comprising a display unit, wherein the modules further comprise a display control module configured to display the test result on the display unit.

12. The server according to claim 11, wherein the result output module outputs the test result with table formal.
